(19) United States
(12) Patent Application Publication
(10) Pub. No.: US 2019/0218690 A1
(43) Pub. Date: Jul. 18, 2019

(54) SIGNALING YARN AND MANUFACTURING METHOD THEREOF

(71) Applicant: INTELLIGENCE TEXTILE TECHNOLOGY CO., LTD., TAIPEI CITY (TW)

(72) Inventor: CHEN-HSIANG LIN, TAIPEI CITY (TW)

(21) Appl. No.: 15/973,566

(22) Filed: May 8, 2018

(30) Foreign Application Priority Data
Jan. 12, 2018 (TW) 107101342

(51) Int. Cl. D02G 3/44; H01B 7/02; H01B 7/18; H01B 1/02; D02G 3/38

(52) U.S. Cl. CPC D02G 3/441; H01B 7/02; H05B 1/0272; H01B 1/02; D02G 3/38; H01B 7/1805

(57) ABSTRACT

The present disclosure provides a signaling yarn having a staple fiber and a sheet conductor. The staple fiber has a stretching resistance of 26 to 40 strands, and functions as a supporting material. The sheet conductor enlaces a surrounding surface of the staple fiber in a spiral extending manner. By selecting the above stretching resistance of the staple fiber, the signaling yarn not only propagates signals and electricity, but is also stretch-resistant, therefore being suitable for weaving and washing. Moreover, wearers wearing textiles weaved from the signaling yarn never experience foreign-body sensation, thus having good user experience.

### CROSS-REFERENCE TO RELATED APPLICATION

This non-provisional application claims priority under 35 U.S.C. § 119(a) on Patent Application No(s). 107101342 filed in Taiwan, R.O.C. on Jan. 12, 2018, the entire contents of which are hereby incorporated by reference.

### TECHNICAL FIELD

The present disclosure relates to a yarn for weaving, and more particularly to a signaling yarn capable of propagating signals and electricity and a method of making the same.

### RELATED ART

With the advancement of technology, many manufacturers are now trying to add electronic components to their clothing to form smart textiles. Smart textiles not only measure the physiological signals of a wearer (user), but also generate and supply heat to the wearer. In a cold environment, by heating the smart textiles, the wearer will not catch cold or feel cold.

Most of the smart textiles are formed from chips, yarns, wires (such as enameled wires) and resistors, wherein the wires are embedded or weaved in textiles weaved from yarns and connected to the resistors and the chips. The wires are connected to an external power source which supplies power to resistors and the chips. Each of the chips includes a controller and sensors for measuring physiological signals. When the external power is supplied to the resistors, the resistors convert electrical energy into thermal energy to heat the smart textiles.

However, the wires of most of the smart textiles are embedded or weaved in the textiles, and therefore the wires may sever in the manufacturing process or washing process of the smart textiles. Moreover, wearers wearing textiles which the wires are embedded or weaved in still experience foreign-body sensation, thus having bad user experience.

### SUMMARY

According to at least one embodiment of the present disclosure, the present disclosure provides a signaling yarn that propagates signals and electricity. The signaling yarn is weaved from conventional yarn and has a certain degree of strength. Therefore, the signaling yarn rarely severs during washing or weaving. In addition, wearers wearing textiles weaved from the signaling yarn never experience foreign-body sensation, and thus the textiles weaved from the signaling yarns provides good user experience. Furthermore, a sheet conductor of the signaling yarn can convert electrical energy into thermal energy to heat the textiles. Moreover, the present disclosure provides a manufacturing method of the signaling yarn.

An embodiment of the present disclosure provides a signaling yarn comprising a staple fiber and a sheet conductor. A stretching resistance of the staple fiber is 26 to 40 strands and the staple fiber functions as a supporting material. The sheet conductor is enlacing a surrounding surface of the staple fiber in a spiral extending manner.

An embodiment of the present disclosure provides a manufacturing method of the signaling yarn including the following steps: providing a staple fiber as a supporting material, wherein a stretching resistance of the staple fiber is 26 to 40 strands; and providing a sheet conductor enlacing a surrounding surface of the staple fiber in a spiral extending manner.

Optionally, an aspect ratio of a cross section of the sheet conductor corresponding to the spiral extending manner is about 10 to 30, and preferably about 20.

Optionally, the signaling yarn comprises an insulating layer enlacing the surrounding surface of the staple fiber for covering the sheet conductor and the staple fiber.

Optionally, the manufacturing method of the signaling yarn further comprises the following steps: forming an insulating layer enlacing the surrounding surface of the staple fiber for covering the sheet conductor and the staple fiber.

Optionally, a material of the sheet conductor is alloy.

Optionally, the alloy is selected from copper-nickel alloy, copper-tin alloy, copper-nickel-silicon alloy, copper-nickel-zinc alloy, copper-nickel-tin alloy, copper-chromium alloy, copper-silver alloy, nickel-brass alloy, phosphor bronze alloy, beryllium copper alloy, nickel-chromium alloy, copper-tungsten alloy and stainless steel.

Optionally, a material of the insulating layer is selected from polytetrafluoroethylene (PTFE, also known as Teflon®), ethylene tetrafluoroethylene (ETFE), polyethylene terephthalate (PET), polyvinyl chloride (PVC) and polyethylene (PE).

Optionally, a conductive wire is rolled for providing the sheet conductor, wherein a diameter of a circular section of the conductive wire is X, a length of the cross section of the sheet conductor is about 4X, and a width of the cross section of the sheet conductor is about X/5.

Optionally, a material of the staple fiber is selected from polyester, polyamide, polyacrylic, polyethylene, polypropylene, cellulose, protein, elastomeric, polytetrafluoroethylene, poly-p-phenylenebenzobisthiazole (PBO), polyetherketone, carbon and glass fiber.

In summary, an embodiment of the present disclosure provides a signaling yarn and a manufacturing method thereof. The signaling yarn uses a staple fiber within specific number of strands as a supporting material and uses a sheet conductor having a specific aspect ratio to enlace a surrounding surface of the staple fiber in a spiral extending manner for increasing the strength of the signaling yarn. Thus, the signaling yarn propagates signals and electricity, has better strength, and rarely severs during washing and weaving. Furthermore, since the size and hardness of the signaling yarn are smaller than those of conventional wires, and the size of the signaling yarn is only slightly larger than the conventional yarn. The wearers wearing textiles weaved from the signaling yarn never experience foreign-body sensation, thus having good user experience.

For better understanding of the features and technical contents of the present disclosure, please refer to the detailed descriptions and drawings of the present disclosure, but such descriptions and drawings are merely illustrative of the present disclosure and not intended to limit the present disclosure.

### BRIEF DESCRIPTION OF THE DRAWINGS

In order to describe the embodiments of the present disclosure or the prior are more clearly, the following briefly introduces the drawings required for describing the embodiment. Apparently, the drawings in the following descriptions are only embodiments of the present disclosure, and persons of ordinary skill in the art may still derive other drawings from these drawings without creative efforts.

FIG. 1 is a three-dimensional diagram illustrating a signaling yarn of an embodiment of the present disclosure;

FIG. 2 is a three-dimensional diagram illustrating the signaling yarn of another one embodiment of the present disclosure;

FIG. 3 is a sectional diagram illustrating the signaling yarn of another one embodiment of the present disclosure;

FIG. 4 is diagram illustrating an implementation method of a sheet conductor of an embodiment of the present disclosure; and

FIG. 5 is a flow chart illustrating a manufacturing method of the signaling yarn of an embodiment of the present disclosure.

### DETAILED DESCRIPTION OF THE PREFERRED EMBODIMENTS

An embodiment of the present disclosure provides a signaling yarn having capability of propagating signals and electricity. The size of the signaling yarn is only slightly larger than the size of a conventional yarn, and the hardness of the signaling yarn is low. Therefore, a wearer will not experience foreign-body sensation. The signaling yarn comprises a staple fiber and a sheet conductor, wherein the staple fiber functions as a supporting material, and the sheet conductor is enlacing a surrounding surface of the staple fiber in a spiral extending manner to increase a stretching resistance of the signaling yarn. In addition, in order to increase the stretching resistance to make the signaling yarn less likely to sever during washing and weaving, the stretching resistance of the staple fiber provided as the supporting material of the embodiment of the present disclosure is designed to be between 26 and 40 strands (for example, 26, 28, 30 and 40 strands), and an aspect ratio of a cross section of the sheet conductor corresponding to the spiral extending manner is designed to be between about 10 and 30. For example, after a continuous 10-day wash test (the typical test standard is 7 days), there is no problem of severance with the above-mentioned signaling yarn, and through a tension test results, the signaling yarn can withstand a tension equivalent to about 15 kg of load (the general standard is 3 kg of load.)

In the embodiment of the present disclosure, the signaling yarn further comprises an insulating layer. The insulating layer enlaces the surrounding surface for covering the sheet conductor and the staple fiber. There are different applications for the signaling yarn with the insulating layer and the signaling yarn without the insulating layer. For example, the signaling yarn without the insulating layer can be used as a sensing element of a touch control textiles, the signaling yarn with the insulating layer can be used as a signal transmission element or a heating element in smart textiles, and the present disclosure is not limited thereto.

In the embodiment of the present disclosure, a length and a width of the cross section of the sheet conductor are approximately 4X and X/5 respectively, wherein X is a diameter of the circular cross section of a conductor blank. The conductor blank is, for example, a conductive wire, which forms the sheet conductor through rolling of a rolling mill. However, the formation of the sheet conductor is not intended to be a limitation of the present disclosure. In addition, a material of the sheet conductor is alloy, such as copper-nickel alloy, copper-tin alloy, copper-nickel-silicon alloy, copper-nickel-zinc alloy, copper-nickel-tin alloy, copper-chromium alloy, copper-silver alloy, nickel-brass alloy, phosphor bronze alloy, beryllium copper alloy, nickel-chromium alloy, copper-tungsten alloy, stainless steel and other commercially conductive alloys, but the present disclosure is not limited thereto.

Moreover, a material of the staple fiber is selected from polyester, polyamides, polyacrylonitriles, polyethylenes, polypropylenes, celluloses, proteins, elastic fibers, poly perfluoroethylene, polyparaphenylene benzoxazole, polyether ketone, carbon and glass fiber, a material of the insulating layer is selected from polytetrafluoroethylene, ethylene Tetrafluoroethylene, polyethylene terephthalate, polyvinyl chloride, polyethylene and other polymer insulation materials, and the present disclosure is not limited thereto.

The signaling yarn and its manufacturing method according to different embodiments of the present disclosure will be further described below with the drawings.

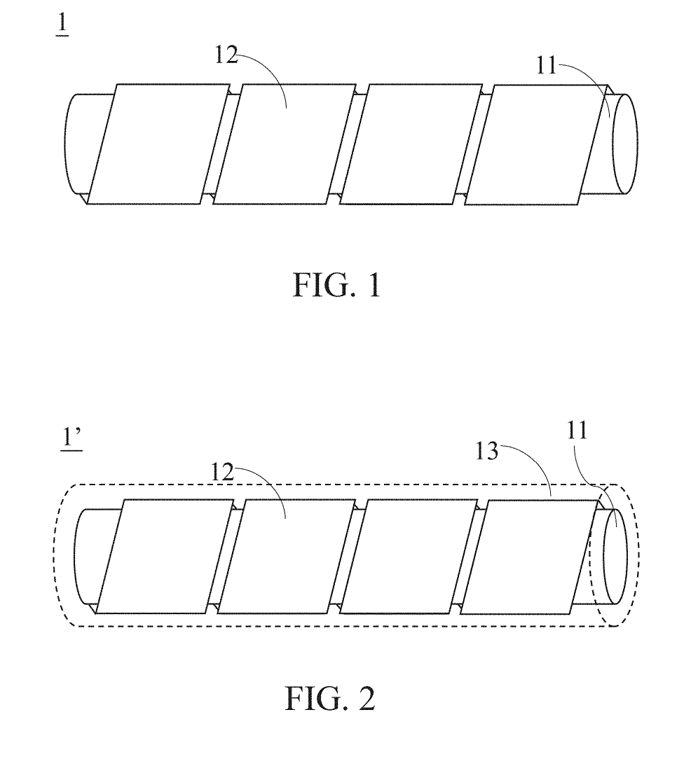

Please refer to FIG. 1, which is a three-dimensional schematic diagram of the signaling yarn according to an embodiment of the present disclosure. The signaling yarn 1 comprises a staple fiber 11 and a sheet conductor 12, and the staple fiber 11 is provided as a supporting material to support the sheet conductor 12 enlacing the staple fiber 11. The sheet conductor 12 is enlacing a surrounding surface of the staple fiber 11 in a spiral extending manner to increase a stretching resistance of the signaling yarn 1.

Optionally, the stretching resistance of the signaling yarn 1 can be further increased by selecting the strength of the staple fiber 11 and/or an aspect ratio of a cross section of the sheet conductor 12 corresponding to the spiral extending manner. In this embodiment, the strength of the staple fiber 11 is selected to be 30 strands, and the aspect ratio of the cross section of the sheet conductor 12 corresponding to the spiral extending manner is selected to be about 20, but the present disclosure is not limited thereto. For example, the staple fiber 11 may have the strength of 26, 28, or 40 strands, or the aspect ratio of the cross section of the sheet conductor 12 corresponding to the spiral extending manner may be selected to be about between 10 and 30.

In the embodiment, a material of the staple fiber 11 is selected from polyester, polyamides, polyacrylonitriles, polyethylenes, polypropylenes, celluloses, proteins, elastic fibers, poly perfluoroethylene, polyparaphenylene benzoxazole, polyether ketone, carbon and glass fiber, and the present disclosure is not limited thereto. The material of the short staple fiber 11 can be selected according to actual demands.

In the embodiment, a material of the sheet conductor is alloy, such as copper-nickel alloy, copper-tin alloy, copper-nickel-silicon alloy, copper-nickel-zinc alloy, copper-nickel-tin alloy, copper-chromium alloy, copper-silver alloy, nickel-brass alloy, phosphor bronze alloy, beryllium copper alloy, nickel-chromium alloy, copper-tungsten alloy, stainless steel and other commercially conductive alloys, but the present disclosure is not limited thereto. In different embodiments, the type of alloy may have different options. For example, the signaling yarn 1 can be used as a touch sensing element in a touch control textile. One end of the signaling yarn 1 receives a scanning signal and the other end of the signaling yarn 1 transmits a touch sensing signal. Therefore, a smaller resistance value of the alloy can be selected as the material of the sheet conductor 12.

Referring to FIG. 2, FIG. 2 is a three-dimensional diagram of a signaling yarn according to another one embodiment of the present disclosure. Compared with the signaling yarn 1 of the embodiment of FIG. 1, the signaling yarn 1′ provided by the embodiment of FIG. 2 further includes an insulating layer 13, wherein the insulating layer 13 enlaces the surrounding surface of the staple fiber 11 so as to cover the sheet conductor 12 and the staple fiber 11. The sheet conductor 12 and the staple fiber 11 of signaling yarn 1′ are the same as those described for the sheet conductor 12 and the staple fiber 11 of the signaling yarn 1 of FIG. 1, and therefore the redundant descriptions thereof are omitted.

In the embodiment, a material of the insulating layer 13 is selected from polytetrafluoroethylene, ethylene tetrafluoroethylene, polyethylene terephthalate, polyvinyl chloride, polyethylene and other polymer insulation materials, and the present disclosure is not limited thereto. The material of the sheet conductor 12 and the insulating layer 13 can be selected according to the actual demand. For example, the signaling yarn 1′ can be used as a heating element for heating textiles, so the sheet conductor 12 can be made of an alloy with a large resistance value, and the insulating layer 13 can be made of an insulating material with high heat resistance (for example, polytetrafluoroethylene).

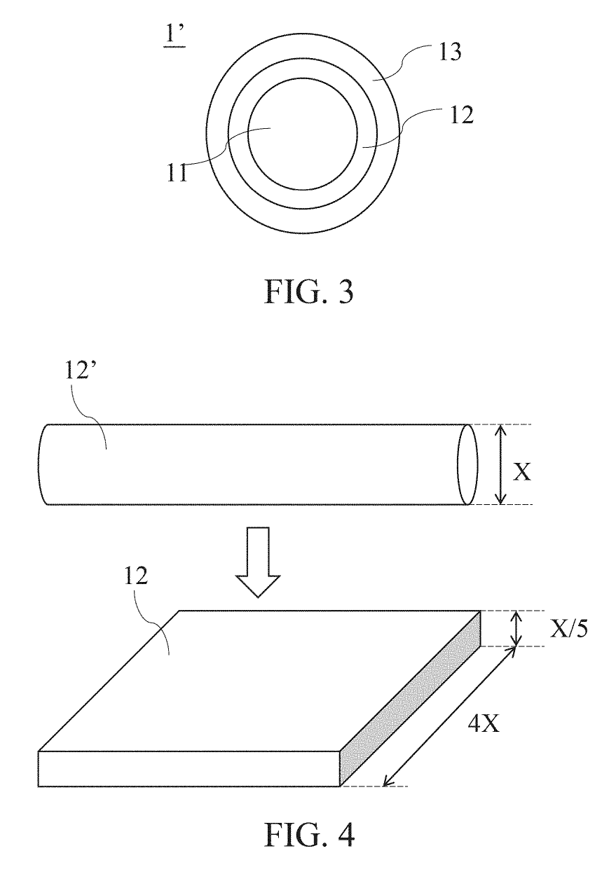

Referring to FIG. 2 and FIG. 3, FIG. 3 is a sectional diagram of a signaling yarn according to another one embodiment of the present disclosure. In the sectional view of the signaling yarn 1′, according to the descriptions above, the staple fiber 11 is provided as the support material of a central layer, and the other two layers beside the staple fiber 11 are sequentially the sheet conductor 12 and insulating layer 13. However, the signaling yarn 1′ of the embodiment has only one sheet conductor 12 and one insulating layer 13, but the present disclosure is not limited thereto. In other embodiments, there may be more layers of sheet conductors and insulating layers, for example, six layers or eight layers, and the number of layers may vary depending on the actual demands.

Referring to FIG. 4, FIG. 4 is diagram illustrating an implementation method of a sheet conductor of an embodiment of the present disclosure. In this embodiment, a length and a width of the cross section of the sheet conductor 12 are approximately 4X and X/5 respectively, wherein X is a diameter of the circular cross-section of the conductive wire 12′. The conductive wire 12′ is rolled by a rolling mill to form the sheet conductor 12. However, the formation of the sheet conductor 12 is not intended to be a limitation of the present disclosure. In other words, there are different implementations of the sheet conductor 12 of the embodiment of the present disclosure.

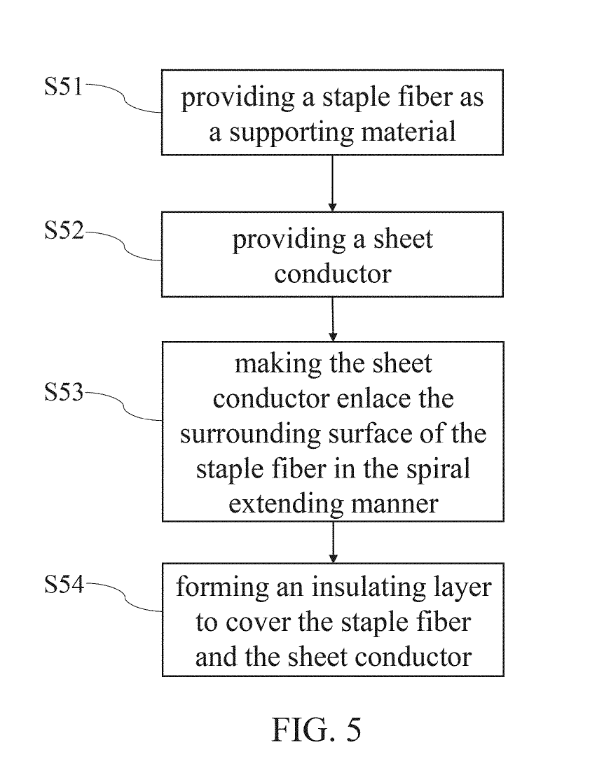

Please refer to FIG. 2 and FIG. 5, FIG. 5 is a flow chart illustrating a manufacturing method of the signaling yarn according to an embodiment of the present disclosure. First, in step S51, a staple fiber 11 is provided as a supporting material, wherein the staple fiber 11 has a stretching resistance of 26 to 40 strands. Next, in step S52, a sheet conductor 12 is provided. Next, in step S53, the sheet conductor 12 is enlacing a surrounding surface of the staple fiber 11 in the spiral extending manner, wherein an aspect ratio of a cross section of the sheet conductor 12 corresponding to the spiral extending manner is about 10 to 30, and preferably about 20. Finally, in step S54, an insulating layer 13 is formed and enlacing the surrounding surface of the staple fiber 11 to cover the staple fiber 11 and the sheet conductor 12, and thus the signaling yarn 1′ of FIG. 2 is manufactured.

Furthermore, in order to manufacture the signaling yarn 1 of FIG. 1 by using the descriptions of the manufacturing method of the signaling yarn 1 of FIG. 5, only steps S51 to S53 of FIG. 5 need to be executed. In addition, the implementation of the sheet conductor 12 provided in step S52 can be the same as the implementation shown in FIG. 4, and the present disclosure is not limited thereto.

In summary, the signaling yarn provided in the embodiments of the present disclosure propagates signals and electricity, has better strength, and rarely severs during washing and weaving. Moreover, since the size and hardness of the signaling yarn are smaller than those of the conventional wires, and the size of the signaling yarn is only slightly larger than the conventional yarn, wearers wearing textiles weaved from the signaling yarn never experience foreign-body sensation, thus having good user experience.

While the present disclosure has been described by means of specific embodiments, numerous modifications and variations could be made thereto by those skilled in the art without departing from the scope and spirit of the present disclosure set forth in the claims.

What is claimed is:

1. A signaling yarn, comprising:
a staple fiber, having a stretching resistance of 26 to 40 strands and functioning as a supporting material; and
a sheet conductor, enlacing a surrounding surface of the staple fiber in a spiral extending manner.

2. The signaling yarn according to claim 1, wherein an aspect ratio of a cross section of the sheet conductor corresponding to the spiral extending manner is about 10 to 30, and preferably about 20.

3. The signaling yarn according to claim 2, the signaling yarn further comprising:
an insulating layer, enlacing the surrounding surface of the staple fiber for covering the sheet conductor and the staple fiber.

4. The signaling yarn according to claim 3, wherein a material of the insulating layer is selected from polytetrafluoroethylene (PTFE, i.e. Teflon®), ethylene tetrafluoroethylene (ETFE), polyethylene terephthalate (PET), polyvinyl chloride (PVC) and polyethylene (PE).

5. The signaling yarn according to claim 1, wherein a material of the sheet conductor is an alloy.

6. The signaling yarn according to claim 5, wherein the alloy is selected from copper-nickel alloy, copper-tin alloy, copper-nickel-silicon alloy, copper-nickel-zinc alloy, copper-nickel-tin alloy, copper-chromium alloy, copper-silver alloy, nickel-brass alloy, phosphor bronze alloy, beryllium copper alloy, nickel-chromium alloy, copper-tungsten alloy and stainless steel.

7. The signaling yarn according to claim 5, the signaling yarn further comprising:
an insulating layer, enlacing the surrounding surface of the staple fiber for covering the sheet conductor and the staple fiber.

8. The signaling yarn according to claim 7, wherein a material of the insulating layer is selected from is selected from polytetrafluoroethylene (PTFE, i.e. Teflon®), ethylene tetrafluoroethylene (ETFE), polyethylene terephthalate (PET), polyvinyl chloride (PVC) and polyethylene (PE).

9. The signaling yarn according to claim 1, wherein a material of the staple fiber is selected from polyester, polyamide, polyacrylic, polyethylene, polypropylene, cellulose, protein, elastomeric, polytetrafluoroethylene, poly-p-phenylenebenzobisthiazole (PBO), polyetherketone, carbon and glass fiber.

10. The signaling yarn according to claim 1, the signaling yarn further comprising:
an insulating layer, enlacing the surrounding surface of the staple fiber for covering the sheet conductor and the staple fiber.

11. The signaling yarn according to claim 10, wherein a material of the insulating layer is selected from is selected from polytetrafluoroethylene (PTFE, i.e. Teflon®), ethylene tetrafluoroethylene (ETFE), polyethylene terephthalate (PET), polyvinyl chloride (PVC) and polyethylene (PE).

12. A manufacturing method for a signaling yarn, comprising:
providing a staple fiber as a supporting material, wherein a stretching resistance of the staple fiber is 26 to 40 strands; and
providing a sheet conductor enlacing a surrounding surface of the staple fiber in a spiral extending manner.

13. The manufacturing method for the signaling yarn according to claim 12, wherein an aspect ratio of a cross section of the sheet conductor corresponding to the spiral extending manner is about 10 to 30, and preferably about 20.

14. The manufacturing method for the signaling yarn according to claim 13, comprising:
forming an insulating layer enlacing the surrounding surface of the staple fiber for covering the sheet conductor and the staple fiber.

15. The manufacturing method for the signaling yarn according to claim 13, wherein a conductive wire is rolled for providing the sheet conductor, wherein a diameter of a circular section of the conductive wire is X, a length of the cross section of the sheet conductor is about 4X, and a width of the cross section of the sheet conductor is about X/5.

16. The manufacturing method for the signaling yarn according to claim 15, comprising:
forming an insulating layer enlacing the surrounding surface of the staple fiber for covering the sheet conductor and the staple fiber.

17. The manufacturing method for the signaling yarn according to claim 12, wherein a material of the staple fiber is selected from polyester, polyamide, polyacrylic, polyethylene, polypropylene, cellulose, protein, elastomeric, polytetrafluoroethylene, poly-p-phenylenebenzobisthiazole (PBO), polyetherketone, carbon and glass fiber.

18. The manufacturing method for the signaling yarn according to claim 12, comprising:
forming an insulating layer enlacing the surrounding surface of the staple fiber for covering the sheet conductor and the staple fiber.
